(19) United States
(12) Patent Application Publication
(10) Pub. No.: US 2007/0111689 A1
(43) Pub. Date: May 17, 2007

(54) Apparatus for selecting a receiver among a plurality of receivers in a diversity receiver system based upon automatic gain correction

(76) Inventors: Hermann Link, Donaueschingen-Grueningen (DE); Stefan Schradi, Villingen-Schwenningen (DE)

Correspondence Address: Patrick J. O'Shea;O'Shea, Getz & Kosakowski, P.C., Suite 912, 1500 Main Street, Springfield, MA, 01115, US

(21) Appl. No.: 11/541,916

(22) Filed: Oct. 2, 2006

Related U.S. Application Data
(63) Continuation of application No. 09/509,643, filed on Jul. 24, 2000, now Pat. No. 7,116,959.

(51) Int. Cl. H04B 17/02

(52) U.S. Cl. 455/136

(57) ABSTRACT

A diversity receiver system includes a plurality of radio receivers that each provide a uniquely associated receiver output signal and a uniquely associated receiver control signal indicative of the amount of gain applied by the associated radio receiver to create the uniquely associated receiver output signal. A selection mechanism receives the receiver control signals, and determines which of the radio receivers has applied the smallest gain correction to its associated receiver output signal, and provides a diversity receiver output signal indicative of the receiver output signal associated with the receiver that applied the smallest gain correction.

### PRIORITY INFORMATION

This application is a continuation of co-pending Ser. No. 09/509,643 filed Mar. 30, 2000.

### BACKGROUND OF THE INVENTION

The invention relates to diversity receivers, and in particular to selecting a receiver among a plurality of receivers in a diversity receiver system based upon automatic gain correction.

Diversity receiving systems with several receivers are used, for example, in vehicles. The receivers can be, for example, audio and video receivers.

Reception and reproduction of video pictures in stationary receiving stations poses no difficulties, because the reception conditions remain largely constant. On the other hand, the reception conditions for a mobile receiving station can vary considerably, depending on the nature of the terrain. For instance, if the mobile receiving station is situated in mountainous terrain, echoes can cause considerable interference with reception. In the radio shadow of mountains or hills, the radio connection can even break down completely, so that, in place of a video picture, only noise is visible on the screen.

In the meantime, motor vehicles such as, for example, passenger cars, long-distance buses, and railroad cars, are being equipped with television receivers and screens, so that messages can be displayed, for example traffic reports sent by video text, or, the travelers can be entertained with television programs. The receiving conditions in a moving receiving station vary considerably in some circumstances, due to the terrain through which the receiving station is currently passing. Consequently, this will subject the travelers who are watching television to unpleasant and considerable eye strain, because the picture quality can vary to a great extent. For example, if the vehicle is passing through a radio shadow, the viewers will see only noise on the screen. Looking at a television program with such interference subjects the viewers to fatigue rather than entertainment.

It is known that the reception of radio signals in mobile receiving stations can be improved by multi-path reception, also referred to as “diversity”. By antenna diversity is understood a receiver which can be connected to one of several antennas, generally spatially separated from one another, while by frequency diversity is understood a system consisting of several receivers which receive the same signals or the same programs on different frequencies. The signals delivered by the antennas in the case of antenna diversity and by the receivers in the case of frequency diversity are tested for their quality, so as to forward and process the best quality signal.

### SUMMARY OF THE INVENTION

It is therefore the object of the invention to specify, for a diversity receiving system with several receivers, to select the receiver with the best reception.

The invention achieves this object by comparing the levels of the control signals of the automatic gain control of the receivers, and selecting that receiver whose control signal has the lowest level.

The invention starts from the idea that the level of the control signal of the automatic gain control of a receiver (e.g., a television receiver) is a measure of the reception level. If the level of the control signal reaches its maximum, the reception level is too low; on the other hand, if the level of the control signal reaches its minimum, the reception level lies in the optimum range.

### BRIEF DESCRIPTION OF THE DRAWING

FIG. 1 is a block diagram illustration of a first embodiment of the invention; and

FIG. 2 is a block diagram illustration of a second embodiment of the invention.

### DETAILED DESCRIPTION OF THE INVENTION

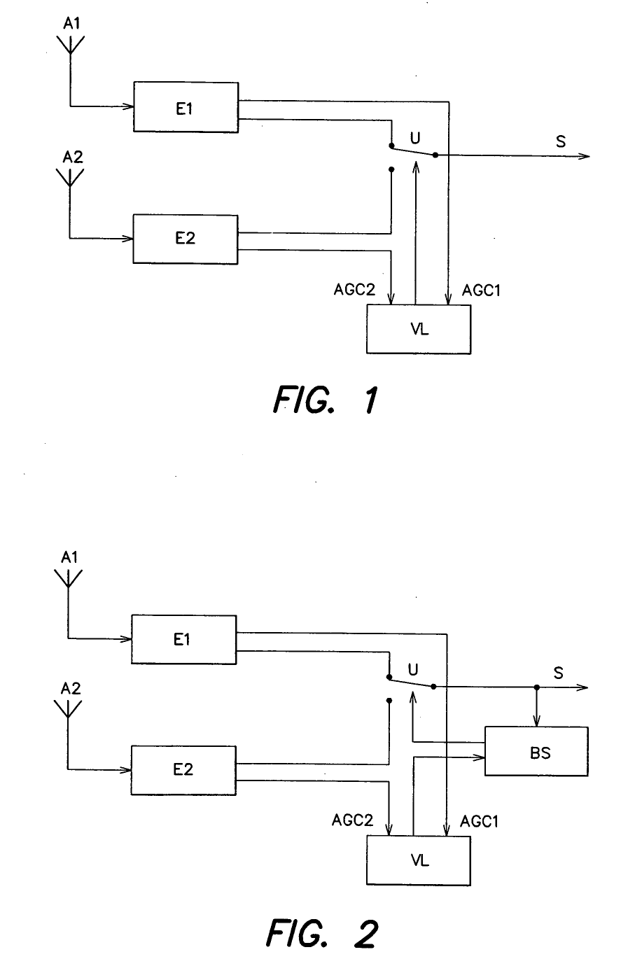

Referring to FIG. 1, two receivers E1 and E2 (e.g., television receivers) receive the same program, with an antenna A1 and A2, respectively. The two control signals AGC1 and AGC2 of the two receivers E1 and E2 are compared in a comparator VL. Via the controllable changeover switch U, the comparator VL selects the output of that receiver whose control signal has the lower level. Consequently, the output signal S of the receiver whose control signal has the lower level is always forwarded for further processing. More than two receivers can also exist here.

The second embodiment of the invention, shown in FIG. 2, will now be described and explained.

The second embodiment differs from the first one in that the output of the comparator VL is not connected to the control input of the controllable changeover switch U, but to the first control input of a block synchronizer BS. The output signal S of one of the two receivers E1 or E2 is conducted to the second control input of the block synchronizer BS. The control output of the block synchronizer BS is connected to the control input of the controllable changeover switch U.

The second embodiment of the invention is suited for the block transmission of signals. The block synchronizer BS receives from the comparator VL a control signal for switching over to one receiver if the level of the control signal of the other receiver becomes greater than the level of the control signal of the first receiver. However, the block synchronizer BS does not switch over to another receiver immediately, but only at the end or beginning of a block. In other words, the block synchronizer BS executes switchover processes with block synchronization. No switchovers are executed within a block.

The second embodiment is especially well suited for a diversity receiving system with television receivers. The switchover process from one receiver to another takes place with line or picture synchronization.

With a third advantageous embodiment of the invention, switchover to another receiver occurs only if the lowest level differs from the levels of the other control signals by a specific minimum value. This measure of providing a hysteresis prevents unnecessary switchover processes.

A special advantage of the invention is that the control signal is present in any case, and the invention can be implemented with only small expense—only a comparator and a controllable changeover switch are needed.

The invention is not limited to television receivers. It is suited for receivers of all kinds for diversity receiving systems. The invention is especially suited for mobile diversity receiving systems, such as are installed for example in vehicles. This can apply to audio and/or video receiving systems. A future application for digital audio transmission is also conceivable.

What is claimed is:

1. A method for selecting one of several receivers of a diversity receiving system, comprising comparing the levels of control signals of the automatic gain control of the receivers, and selecting that receiver whose control signal has the lowest level.

2. The method of claim 1, where a switchover to another receiver occurs only if the level of its control signal lies below the level of the other control signal by a specifiable minimum.

3. The method of claim 1, where at least one of the receivers is a mobile diversity receiving system.

4. The method of claim 3, where at least one of the receivers is a video receiver.

5. The method of claim 4, where switch-over in response to selection of the receiver is selected whose control signal has the lowest level is performed between block of data transmissions.

6. The method of claim 4, where switchover from one video receiver to another one occurs with line or picture synchronization.

7. A receiver selection system that provides an output signal selected from at least a first and second radio receiver, the selection system comprising:
a comparator that receives a first control signal from one of the radio receivers and a second control signal from another of the radio receivers, and determines which of the control signals has the lowest level value and provides a selection signal indicative of the selected control signal; and
a switching element responsive to the selection signal, which receives a first data signal from the first radio receiver and a second data signal from the second radio receiver, and based upon the state of the selection signal selects as the output signal either the first data signal or the second data signal.

8. The receiver selection system of claim 7, where the first and second control signals are indicative of the amount of automatic gain control correction applied by the first and second radio receivers, respectively to their received signals to provide the first and second data signals.

9. The receiver selection system of claim 8, where the first and second data signals include audio data.

10. The receiver selection system of claim 8, where the first and second data signals include video data.

11. A diversity receiver system, comprising:
a plurality of radio receivers that each provide a uniquely associated receiver output signal and a uniquely associated receiver control signal indicative of received radio signal power; and
means, responsive to the receiver control signals, for determining which of the radio receivers has applied the smallest gain correction to its associated receiver output signal, and for providing a diversity receiver output signal indicative of the receiver output signal associated with the receiver that applied the smallest gain correction.

12. The diversity receiver system of claim 11, where the means for determining comprises a block synchronizer that delays switching/coupling the diversity receiver output signal from selection from a first of the radio receivers to a second of the radio receivers in response to the receiver control signals, until the first of the radio receivers has completed transmitting a predefined block of data.

13. The diversity receiver system of claim 12, where the plurality of radio receivers comprising a plurality of television receivers.

14. The diversity receiver system of claim 13, where the plurality of radio receivers comprising a plurality of audio receivers.

15. The diversity receiver system of claim 13, where the means for determining comprises:
a comparator that compares the receiver control signals to determine which of the radio receivers has applied the smallest gain correction to its associated receiver output signal, and provides a selection signal indicative thereof; and
means responsive to the selection signal and the receiver output signals for coupling a selected one of the receiver output signals to the diversity receiver output signal based upon the state of the selection signal.
